(19) United States
(12) Patent Application Publication
(10) Pub. No.: US 2021/0217385 A1
(43) Pub. Date: Jul. 15, 2021

(54) INFORMATION-PROCESSING APPARATUS, DISPLAY DEVICE, AND INFORMATION-PROCESSING METHOD

(71) Applicant: CANON KABUSHIKI KAISHA, Tokyo (JP)

(72) Inventors: Yasuo Suzuki, Kanagawa (JP); Yasuhiro Matsuura, Kanagawa (JP)

(21) Appl. No.: 17/146,740

(22) Filed: Jan. 12, 2021

(30) Foreign Application Priority Data
Jan. 14, 2020 (JP) 2020-003704

(51) Int. Cl. G09G 5/36

(52) U.S. Cl. CPC G09G 5/363; G09G 2340/12; G09G 2320/0626

(57) ABSTRACT

An information-processing apparatus comprising: an obtainment unit configured to obtain an input image; and a generation unit configured to generate a graph image indicating brightnesses in the input image, the graph image having at least an axis representing brightness, wherein the generation unit, in a case of generating the graph image indicating a brightness range including a first range and a second range, with the first range being a brightness range of not more than a predetermined brightness, and with the second range being a brightness range of at least the predetermined brightness and having a brightness span of at least a brightness span of the first range, generates the graph image such that a size of the second range is smaller than a size of the first range.

### BACKGROUND OF THE INVENTION

### Field of the Invention

The present invention relates to an information-processing apparatus, a display device, and an information-processing method.

### Description of the Related Art

High-dynamic-range (HDR) images having a dynamic range wider than the standard dynamic range (SDR) are now in use widely. For the HDR images. Hybrid Log-Gamma signals (hereinafter referred to as HLG signals) that are defined in ITU Rec. 2100 Standard may be used. The ITU Rec. 2100 standard prescribes that the display peak brightness of HLG signals is 1000 cd/m² in the standard viewing environment (reference viewing environment).

For HLG data values (gradation values) of 10-bit representation of HLG signals, narrow range representation is typically used, in which a brightness range of 0 to 1000 cd/m² corresponds to a range narrower than the HLG data value range of 0 to 1023. For example, as shown in FIG. 12A, an HLG data value of 940 corresponds to 1000 cd/m².

Further, standardization of a technology that uses HLG data values more effectively is being studied. Specifically, the use of values greater than the HLG data value of 940 (hereinafter referred to as over-write values) makes it possible to display an image having a brightness of up to about 2000 cd/m², as indicated by the thick line in FIG. 12A.

Japanese Patent Application Laid-Open No. 2019-17108 describes another technique that displays a brightness histogram of an image. A technique is also known that displays a waveform-monitor image (graph), such as the image shown in FIG. 12B, on a display unit to allow a user to recognize brightnesses and pixel positions (positions along a horizontal line at a certain vertical position) in an image.

However, with the techniques of Japanese Patent Application Laid-Open No. 2019-17108 and FIG. 12B, a variation in the position along the brightness scale corresponds linearly to a variation in brightness. As a result, the intervals of the brightness scale on the vertical axis are reduced when the graph shows higher brightnesses than 1000 cd/m², which correspond to over-white values. This lowers the legibility of the graph displayed, such as a histogram or a waveform-monitor image.

### SUMMARY OF THE INVENTION

It is an objective of the present invention to improve the legibility of a graph showing brightnesses in an image.

An aspect of the present invention is:

an information-processing apparatus comprising at least one memory and at least one processor which function as:

an obtainment unit configured to obtain an input image; and

a generation unit configured to generate a graph image indicating brightnesses in the input image, the graph image having at least an axis representing brightness, wherein

the generation unit, in a case of generating the graph image indicating a brightness range including a first range and a second range, with the first range being a brightness range of not more than a predetermined brightness, and with the second range being a brightness range of at least the predetermined brightness and having a brightness span of at least a brightness span of the first range, generates the graph image such that a size of the second range is smaller than a size of the first range.

An aspect of the present invention is:

an information-processing apparatus comprising at least one memory and at least one processor which function as:

an obtainment unit configured to obtain an input image; and

a generation unit configured to generate a graph image indicating brightnesses in the input image, the graph image having at least an axis representing brightness, wherein

the generation unit, in a case of generating the graph image indicating a brightness range including a first range and a second range, with the first range being a brightness range less than a predetermined brightness, and with the second range being a brightness range greater the predetermined brightness, generates the graph image such that the first range and the second range are superimposed on each other.

An aspect of the present invention is:

an information-processing method comprising:

an obtainment step of obtaining an input image; and

a generation step of generating a graph image indicating brightnesses in the input image, the graph image having at least an axis representing brightness, wherein

the generation step, in a case of generating the graph image indicating a brightness range including a first range and a second range, with the first range being a brightness range of not more than a predetermined brightness, and with the second range being a brightness range of at least the predetermined brightness and having a brightness span of at least a brightness span of the first range, includes generating the graph image such that a size of the second range is smaller than a size of the first range.

An aspect of the present invention is:

an information-processing method comprising:

an obtainment step of obtaining an input image; and

a generation step of generating a graph image indicating brightnesses in the input image, the graph image having at least an axis representing brightness, wherein

the generation step, in a case of generating the graph image indicating a brightness range including a first range and a second range, with the first range being a brightness range less than a predetermined brightness, with the second range being a brightness range greater than the predetermined brightness, includes generating the graph image such that the first range and the second range are superimposed on each other.

Further features of the present invention will become apparent from the following description of exemplary embodiments with reference to the attached drawings.

### BRIEF DESCRIPTION OF THE DRAWINGS

FIG. 1 is a diagram showing the configuration of a display device of a first embodiment:

FIG. 2 is a flowchart showing the process of superimposing a waveform-monitor image of the first embodiment;

FIG. 3A is a diagram showing a linear image of the first embodiment;

FIG. 3B is a diagram showing a waveform-monitor image of the first embodiment;

FIG. 4A is a diagram showing a linear image of the first embodiment:

FIG. 4B is a diagram showing a waveform-monitor image of the first embodiment;

FIG. 5 is a diagram illustrating a change in the size of a waveform-monitor image of the first embodiment;

FIG. 6 is a diagram showing the configuration of a display device of a second embodiment;

FIG. 7A is a diagram showing a histogram of the second embodiment;

FIG. 7B is a diagram showing a waveform-monitor image of the second embodiment:

FIG. 8 is a diagram showing the configuration of a display device of a third embodiment:

FIGS. 9A and 9B are diagrams showing waveform-monitor images of the third embodiment;

FIG. 10 is a diagram showing the configuration of a display device of a fourth embodiment:

FIGS. 11A and 11B are diagrams showing waveform-monitor images of the fourth embodiment;

FIG. 12A is a graph showing correspondences between data values and brightnesses; and

FIG. 12B is a diagram illustrating a conventional waveform-monitor image.

### DESCRIPTION OF THE EMBODIMENTS

### First Embodiment

Referring to drawings, a display device (information-processing apparatus) of a first embodiment is now described. The display device of the present embodiment displays a display image, which is based on an input image, with a waveform-monitor image relating to the input image (display image) superimposed on the display image to allow the user to recognize brightnesses in the input image. In the present embodiment, the waveform-monitor image is an image of a graph showing the relationship between brightnesses and positions in the input image. In the present embodiment, brightness is data brightness that the image has as data.

Display Device Configuration

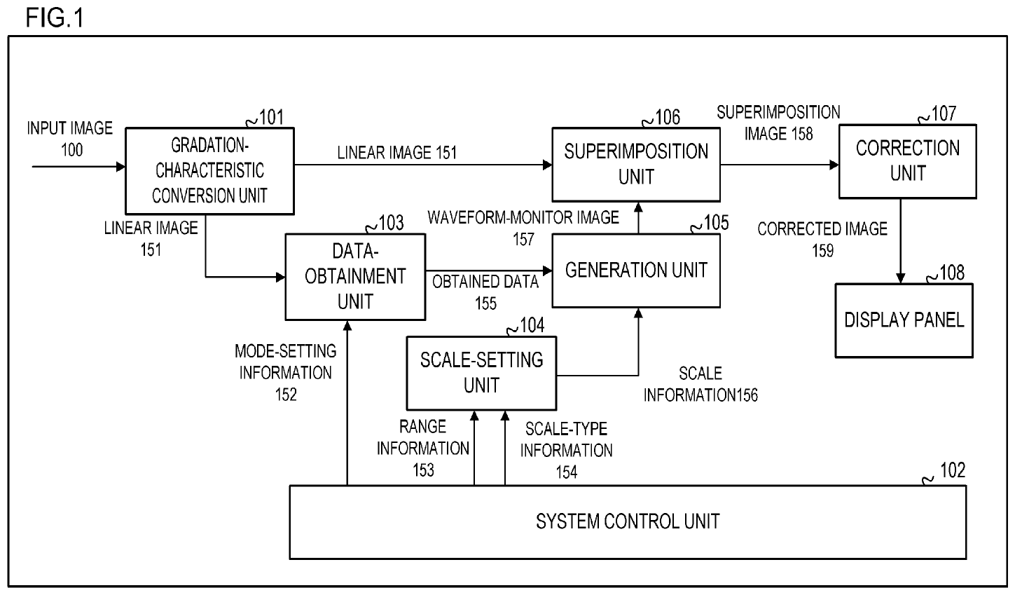

FIG. 1 is a diagram showing the configuration of a display device of the present embodiment. The display device includes a gradation-characteristic conversion unit 101, a system control unit 102, a data-obtainment unit 103, a scale-setting unit 104, a generation unit 105, a superimposition unit 106, a correction unit 107, and a display panel 108.

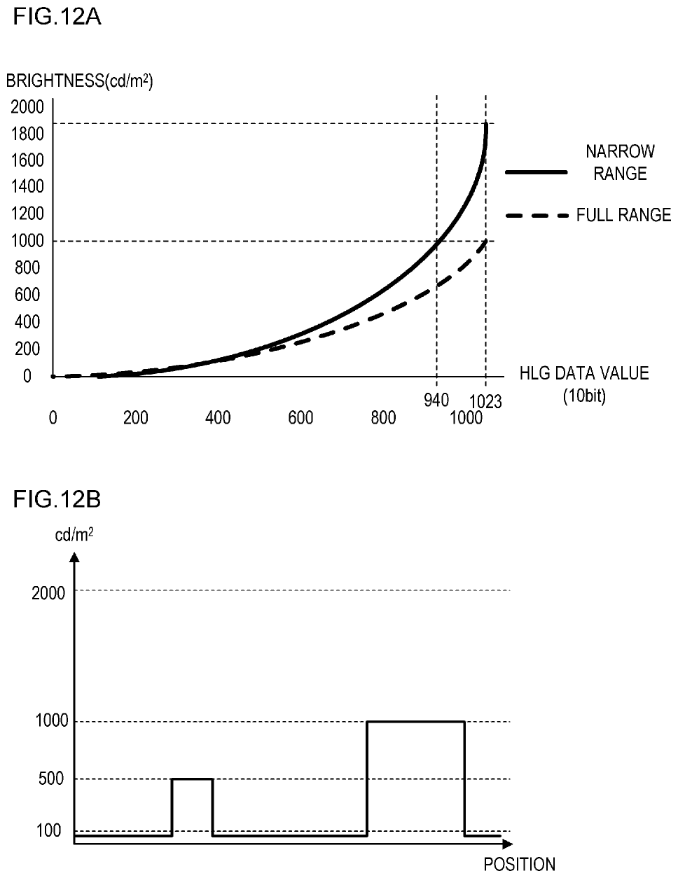

The gradation-characteristic conversion unit 101 obtains an input image 100 represented by data values (HLG data values, gradation values) in which the correspondence between the data values and the brightnesses has the HLG characteristics as shown in FIG. 12A. The input image 100 is input to the gradation-characteristic conversion unit 101 via a serial digital interface (SDI). The input image 100 may be input by IP transmission via HDMI (registered trademark) or LAN.

The gradation-characteristic conversion unit 101 then obtains a linear image 151 in which the HLG data values in the input image 100 are converted such that the data values linearly correspond to brightnesses. The gradation-characteristic conversion unit 101 outputs the linear image 151 to the data-obtainment unit 103 and the superimposition unit 106. The linear image 151 is represented by a 16-bit RGB signal, and the data brightness of the linear image 151 is defined by absolute brightness (cd/m²). In the present embodiment, the linear image 151 has a brightness range of 0 to 2000 cd/m².

The system control unit 102 sets parameters used by functional units. In this embodiment, the parameters include mode-setting information 152, range information 153, and scale-type information 154. The system control unit 102 outputs the mode-setting information 152 to the data-obtainment unit 103, and outputs the range information 153 and the scale-type information 154 to the scale-setting unit 104.

The mode-setting information 152 may indicate one of a mode for obtaining brightnesses along a horizontal line and a mode for obtaining brightnesses along a vertical line, for example. In the present embodiment, the mode-setting information 152 indicates the mode for obtaining brightnesses along a horizontal line, and also includes information indicating the vertical position of the horizontal line for obtaining brightnesses from the linear image 151.

The range information 153 indicates one of narrow range (limited range) and full range. With the full range of the present embodiment, as indicated by the broken line in FIG. 12A, the HLG data value corresponding to 1000 cd/m² is mapped at 1023, and the HLG data value corresponding to 0 cd/m² is mapped at 0. With the narrow range of the present embodiment, as indicated by the thick line in FIG. 12A, the HLG data value corresponding to 1000 cd/m² is mapped at 940, and the HLG data value corresponding to 0 cd/m² is mapped at 64. That is, with the narrow range, a range of 0 to 1000 cd/m² corresponds to a range narrower than the range of possible HLG data values. As such, with the narrow range, there are HLG data values that correspond to brightnesses higher than 1000 cd/m² (predetermined brightness).

The scale-type information 154 indicates a display appearance of scales for graph display. The scale-type information 154 indicates a scale display appearance, such as brightness display in which the scale on the vertical axis represents brightness, and data value display in which the scale on the vertical axis represents HLG data values. In the following descriptions, including the second to fourth embodiments, the scale-type information 154 indicates the brightness display.

The system control unit 102 may determine setting values (values of mode-setting information 152, range information 153, and scale-type information 154) by retrieving initial parameters stored in a storage unit (e.g., non-volatile memory) at startup. Further, a user may modify the setting values.

The data-obtainment unit 103 obtains from the linear image 151 the brightnesses along the horizontal line indicated by the mode-setting information 152. Since the linear image 151 is obtained by converting the gradation characteristics of the input image 100, “obtaining brightnesses from the linear image 151” is equivalent to “obtaining brightnesses in the input image 100”. The data-obtainment unit 103 outputs the obtained brightnesses as obtained data 155 to the generation unit 105.

The scale-setting unit 104 sets a display appearance of scales (scale type; units on the vertical axis and the horizontal axis) based on the scale-type information 154. The scale-setting unit 104 sets a scale (e.g., the maximum value and intervals of the scale) based on the range information 153. The scale-setting unit 104 outputs the scale type and information on the scale as scale information 156 to the generation unit 105. The scale type and the method for setting the scale will be described below.

Based on the obtained data 155 and the scale information 156, the generation unit 105 generates a waveform-monitor image 157 to be superimposed on the linear image 151. The generation unit 105 outputs the waveform-monitor image 157 to the superimposition unit 106.

The superimposition unit 106 superimposes the waveform-monitor image 157 on the linear image 151. The superimposition unit 106 outputs an image in which the waveform-monitor image 157 is superimposed on the linear image 151 as a superimposition image 158 to the correction unit 107.

The correction unit 107 performs gamma correction, color gamut correction, and screen unevenness correction suitable for the characteristics of the display elements of the display panel 108 on the superimposition image 158. These corrections allow the image to be displayed on the display panel 108 with appropriate gradation, color, and screen uniformity. The correction unit 107 outputs the superimposition image 158 on which the corrections are performed as a corrected image 159.

In the present embodiment, the correction unit 107 corrects the superimposition image 158 (the image generated by the superimposition unit 106 by superimposing the waveform-monitor image 157 on the linear image 151) to generate the corrected image 159. Instead, the superimposition unit 106 may superimpose the waveform-monitor image 157 onto an image generated by the correction unit 107 by correcting the linear image 151. That is, the order of processes of the superimposition unit 106 and the correction unit 107 may be reversed from the order described above.

The display panel 108 is a display unit that displays an image based on the corrected image 159. That is, the display panel 108 displays an image in which the waveform-monitor image 157 relating to the input image 100 (display image) is superimposed on a display image that is based on the input image 100. The display panel 108 of the present embodiment is a liquid crystal panel in which the display elements are arranged in a matrix. The display panel 108 may be an organic EL panel. The display elements of the display panel 108 of the present embodiment have the gamma characteristics. The display panel 108 may be external to the display device. In this case, the display device may be considered as an information-processing apparatus.

Superimposing of Waveform-Monitor Image

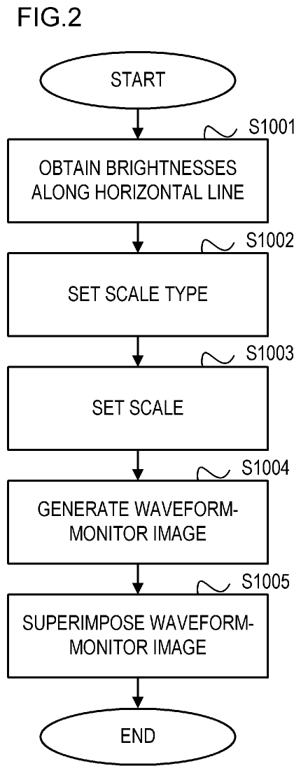

Referring to the flowchart of FIG. 2, a process of superimposing a waveform-monitor image 157 of the present embodiment on a linear image 151 (superimposition method, information-processing method, control method) is now described. The process of the flowchart starts when the data-obtainment unit 103 obtains a linear image 151 from the gradation-characteristic conversion unit 101 and mode-setting information 152 from the system control unit 102. The steps in the flowchart of FIG. 2 are performed by functional units based on a program stored in a storage unit (not shown).

S1001

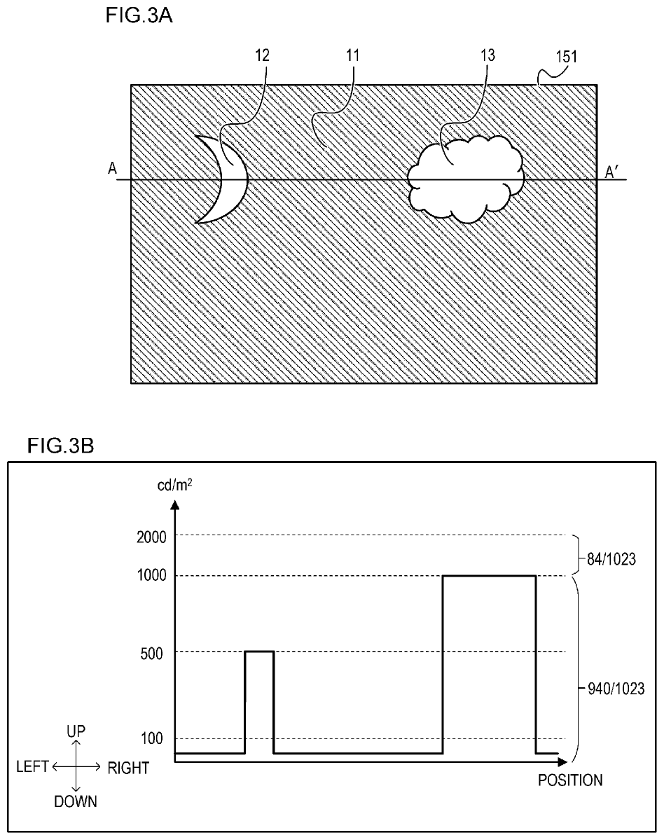

In S1001, the data-obtainment unit 103 obtains from the linear image 151 the brightnesses along the horizontal line indicated by the mode-setting information 152. For example, the data-obtainment unit 103 obtains the brightness of each pixel along line A-A′ on the linear image 151 shown in FIG. 3A. When the number of pixels in the horizontal direction of the linear image 151 shown in FIG. 3A is 4096, the data-obtainment unit 103 obtains the brightnesses of 4096 pixels. The data-obtainment unit 103 outputs the obtained pixel brightnesses as obtained data 155 to the generation unit 105. In the linear image 151 shown in FIG. 3A, the background 11 has a brightness of 50 cd/m², the moon 12 has a brightness of 500 cd/m², and the cloud 13 has a brightness of 1000 cd/m².

For example, the data-obtainment unit 103 may use Expression (1) below to obtain the brightness Y of each pixel from the linear image 151 represented by an RGB signal. R, G, and B in Expression (1) are the R value, G value, and B value of a pixel in the linear image 151.

Y=0.7×G+0.2×R+0.1×B Expression (1)

S1002

In S1002, based on the scale-type information 154, the scale-setting unit 104 sets a scale type for the vertical axis of the waveform-monitor image 157. In the present embodiment, since the scale-type information 154 indicates the brightness display, the scale-setting unit 104 sets the scale type of the display appearance that uses cd/m² as the unit on the vertical axis. Alternatively, a display appearance that uses HLG data values (0 to 1023 in 10 bits) or a display appearance using IRE, which is a unit indicating HLG data values in relative values, may be used as the scale type.

S1003

In S1003, based on the range information 153, the scale-setting unit 104 sets the scale to be used for the waveform-monitor image 157. The range information 153 indicates full range or narrow range.

When the range information 153 indicates the full range, the display panel 108 can represent brightness of up to 1000 cd/m². The scale-setting unit 104 therefore sets the maximum scale value to 1000. Here, the scale-setting unit 104 sets the scale such that a variation in brightness and a variation in the position on the vertical axis (scale value) have linear characteristics (are proportional to each other).

When the range information 153 indicates the narrow range, the display panel 108 can represent brightness of up to 2000 cd/m². The scale-setting unit 104 therefore sets the maximum scale value to 2000. As shown in FIG. 3B, the scale-setting unit 104 sets the scale for a range of 0 to 1000 cd/m² such that a variation in brightness and a variation in the position on the vertical axis (scale value) have linear characteristics. The scale-setting unit 104 sets a narrower display width (length) for the range of 1000 to 2000 cd/m² as compared with the range of 0 to 1000 cd/m² (that is, the range of 1000 to 2000 cd/m² is displayed in a smaller size than the range of 0 to 1000 cd/m²). As a result, the brightness range of not more than 1000 cd/m², which corresponds to a wide range of HLG data values and may require focused attention, is displayed over a larger area in the waveform-monitor image 157. This improves the legibility of brightnesses in the waveform-monitor image 157. For the range of 1000 to 2000 cd/m², the scale may be set such that a variation in brightness and a variation in the position on the vertical axis (scale value) have non-linear characteristics (are non-proportional to each other).

The waveform-monitor image 157 indicates a brightness range of 0 to the maximum scale value set by the scale-setting unit 104. As such, setting the maximum scale value by the scale-setting unit 104 may be considered as setting the brightness range of the waveform-monitor image 157.

In the present embodiment, in the brightness range indicated by the waveform monitor, the brightness range of not more than 1000 cd/m² (not more than predetermined brightness) and the brightness range of at least 1000 cd/m² (at least predetermined brightness) have the same brightness span (amount). However, the scale-setting unit 104 sets the display width (size) for the brightness range of more than or equal to 1000 cd/m² to be narrower (smaller) than the display width (size) for the brightness range less than or equal to 1000 cd/m². This improves the legibility for the range of 0 to 1000 cd/m², which corresponds to many HLG data values. The predetermined brightness serving as the threshold between the different display widths is not limited to 1000 cd/m², and may be 800 cd/m² or 1200 cd/m². That is, in the brightness range indicated by the waveform monitor, the brightness range of at least the threshold brightness between the different display widths may have a at least or not more than brightness span of the brightness range of not more than the threshold brightness (not more than predetermined brightness) between the different display widths.

Further, the ratio between the display widths may be set based on the HLG data values. In the waveform-monitor image 157 shown in FIG. 3B, a 10-bit HLG data value of 940 corresponds to a brightness of 1000 cd/m². Thus, the scale-setting unit 104 sets the ratio between the display width for 0 to 1000 cd/m², which corresponds to HLG data values of 0 to 940, and the display width for 1000 to 2000 cd/m², which corresponds to HLG data values of 940 to 1023, to 940:1023-939, or 940:84. Alternatively, in consideration of the legibility for 1000 to 2000 cd/m², the scale-setting unit 104 may use a predetermined value α and set the ratio between the display width for 0 to 1000 cd/m² and the display width for 1000 to 2000 cd/m² to 940+α:84+α.

When the scale-type information 154 indicates the data value display, the scale-setting unit 104 may determine the maximum scale value as 1023 regardless of the range information 153. Here, the scale-setting unit 104 may set the scale such that a variation in HLG data value and a variation in the position on the vertical axis (scale value) have linear characteristics.

S1004

In S1004, the generation unit 105 generates a waveform-monitor image 157 based on the obtained data 155 and the scale information 156.

First, the generation unit 105 determines the scale on the vertical axis of the waveform-monitor image 157 based on the scale information 156. The generation unit 105 generates a waveform-monitor image on which data has yet to be plotted, by setting the scale on the horizontal axis as horizontal positions. Then, the generation unit 105 plots the brightnesses indicated by the obtained data 155 on the waveform-monitor image 157 according to the scale on the vertical axis. The generation unit 105 outputs the generated waveform-monitor image 157 to the superimposition unit 106.

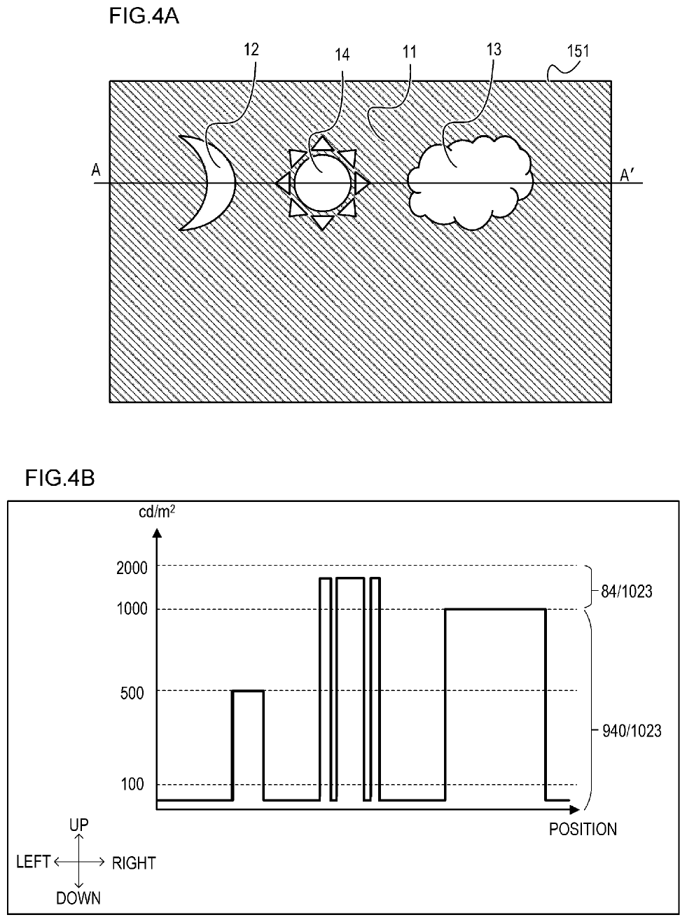

FIG. 4A shows a linear image 151 including pixels with a brightness higher than 1000 cd/m². In FIG. 4A, the sun 14 is added to the image shown in FIG. 3A, and the region of the sun 14 has a brightness of about 2000 cd/m². FIG. 4B is a waveform-monitor image 157 of the present embodiment showing the brightnesses along line A-A′ in FIG. 4A. This waveform-monitor image 157 shows a brightness of about 2000 cd/m² in the region of the sun 14, and has a shorter scale interval for the brightness greater than or equal to 1000 cd/m.

S1005

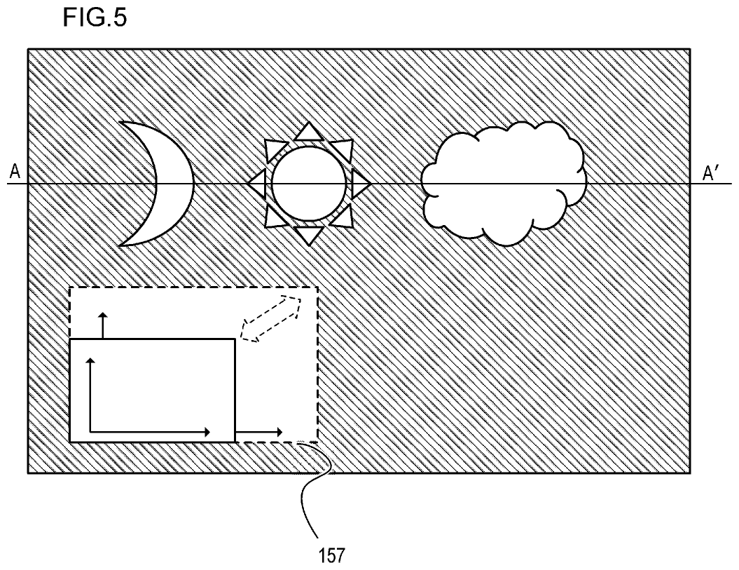

In S1005, the superimposition unit 106 superimposes the waveform-monitor image 157 on the linear image 151. To avoid interfering with the visual clarity of the linear image 151, the superimposition unit 106 superimposes the waveform-monitor image 157 on the lower left in the linear image 151. The waveform-monitor image 157 may be displayed at any position and in any size as long as it does not interfere with the visual clarity, and may be freely changed as shown in FIG. 5 by user input.

In the example of the present embodiment, the data-obtainment unit 103 obtains brightnesses along one line, but brightnesses may be obtained over the entire linear image 151. In this case, the mode-setting information 152 indicates a mode for obtaining the brightnesses of the entire image. For example, assuming that the linear image 151 has 4096 pixels in the horizontal direction and 2160 pixels in the vertical direction, the data-obtainment unit 103 may obtain the brightness of each of 4096×2160 pixels depending on the mode-setting information 152. The generation unit 105 plots the obtained brightnesses on the waveform-monitor image 157. Here, the generation unit 105 may plot the brightnesses on the waveform-monitor image 157 such that a position indicating a brightness corresponding to a greater number of pixels has a darker color, while a position indicating a brightness corresponding to a fewer number of pixels has a lighter color.

Steps S1002 and S1003 may be performed before Step S1001. That is. Step S1001 may be performed after Steps S1002 and S1003.

Controlling the scale of the waveform-monitor image as described above can improve the legibility of the displayed waveform-monitor image.

### Second Embodiment

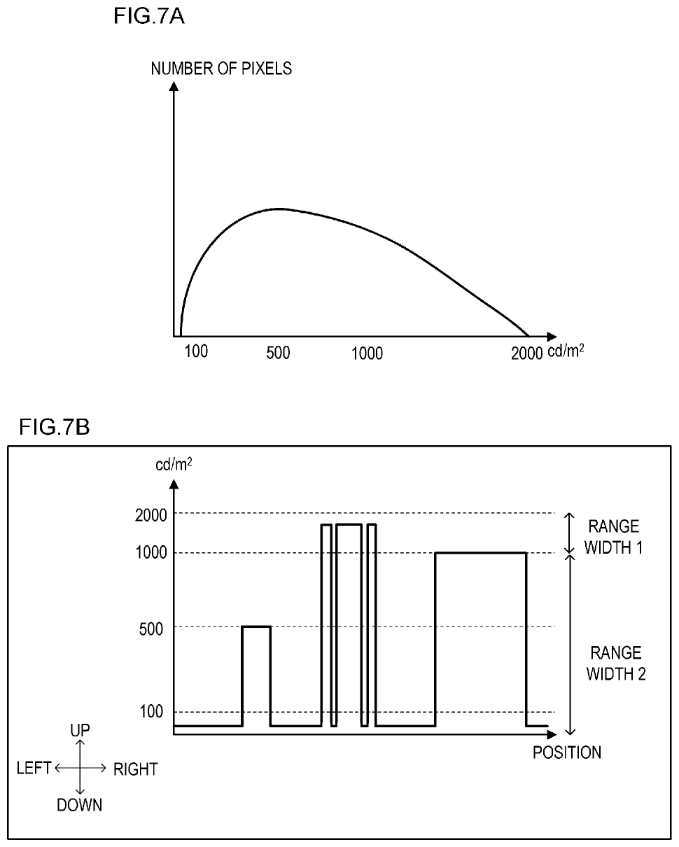

A display device of a second embodiment generates a histogram (brightness histogram) from a linear image (see FIG. 7A), and sets a scale of a waveform-monitor image based on the histogram.

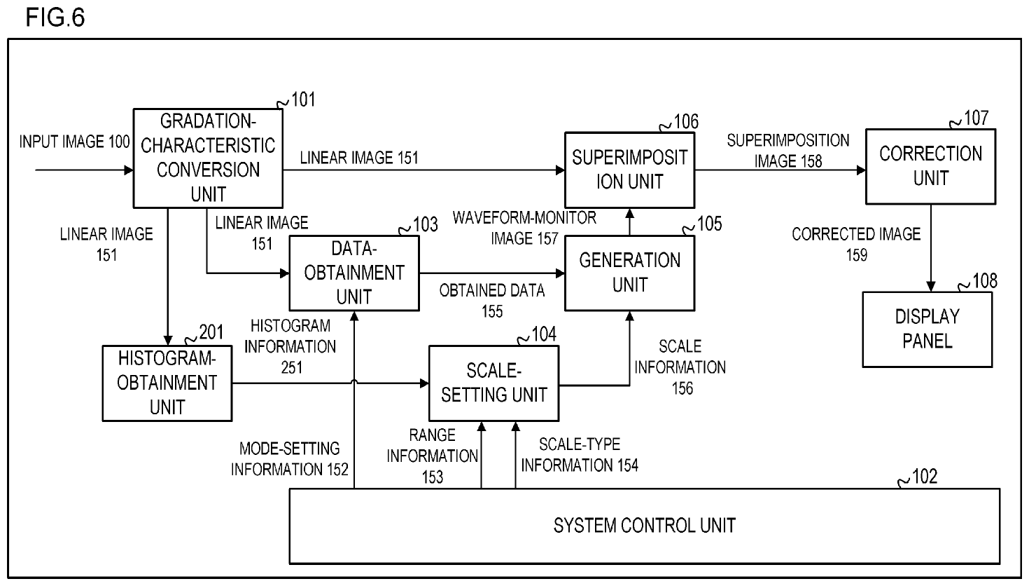

FIG. 6 shows the configuration of the display device of the second embodiment. In addition to the functional units of the first embodiment, the display device of the present embodiment includes a histogram-obtainment unit 201. Only the differences from the display device of the first embodiment are described below.

The histogram-obtainment unit 201 obtains the brightness of each pixel in the linear image 151 and generates histogram information 251 based on the brightnesses. As shown in FIG. 7A, in the histogram information 251, the horizontal axis represents brightness and the vertical axis represents the number of pixels corresponding to each brightness. The example of FIG. 7A indicates that many pixels have a brightness of about 500 cd/m² in the linear image 151.

The scale-setting unit 104 sets a scale based on the histogram information 251. Here, only the method for setting the display widths differs from that of the first embodiment. As shown in FIG. 7B, the scale-setting unit 104 sets a display width for a brightness range of at least 1000 cd/m² (at least predetermined brightness)(Range width 1 shown in FIG. 7B) and a display width for a brightness range of not more than 1000 cd/m² (Range width 2 shown in FIG. 7B) based on the histogram information 251.

When the number of pixels having a brightness higher than (or at least) 1000 cd/m² in the histogram information 251 exceeds a predetermined number, the scale-setting unit 104 increases Range width 1 and reduces Range width 2. When the number of pixels having a brightness higher than (or at least) 1000 cd/m² in the histogram information 251 is less than the predetermined number, the scale-setting unit 104 reduces Range width 1 and increases Range width 2. That is, when the number of pixels having a brightness higher than 1000 cd/m² exceeds the predetermined number, Range width 1 is greater than when the number of the pixels having a brightness higher than 1000 cd/m² is less than the predetermined number. The scale-setting unit 104 may set the range widths such that the ratio between Range width 1 and Range width 2 is equal to the ratio between the number of pixels having a brightness higher than (or at least) 1000 cd/m² and the number of pixels having a brightness lower than (or not more than) 100 cd/m².

As described above, the present embodiment sets the scale of the waveform-monitor image based on the histogram information, thereby improving the legibility of the displayed waveform-monitor image.

Range widths 1 and 2 may be modified according to the size in which the waveform-monitor image 157 is displayed. As described in the first embodiment, the superimposition unit 106 can change the size of the waveform-monitor image 157 superimposed on the image (see FIG. 5).

The waveform-monitor image 157 displayed in a larger size has better legibility. Thus, when the displayed waveform-monitor image 157 is larger than a predetermined size, the scale-setting unit 104 may set Range width 1 and Range width 2 to be equivalent (or the same). When the displayed waveform-monitor image 157 is smaller than the predetermined size, a smaller waveform-monitor image 157 may result in a larger Range width 2 relative to Range width 1. When the waveform-monitor image 157 is larger than the predetermined size, Range width 1 may be larger relative to Range width 2 than when the waveform-monitor image 157 is smaller than the predetermined size.

As such, the display widths (range width, size) in the waveform-monitor image can be appropriately changed according to the size of the waveform-monitor image, thereby improving the legibility of the displayed waveform-monitor image.

### Third Embodiment

A display device of a third embodiment displays two brightness ranges superimposed on each other in a waveform-monitor image.

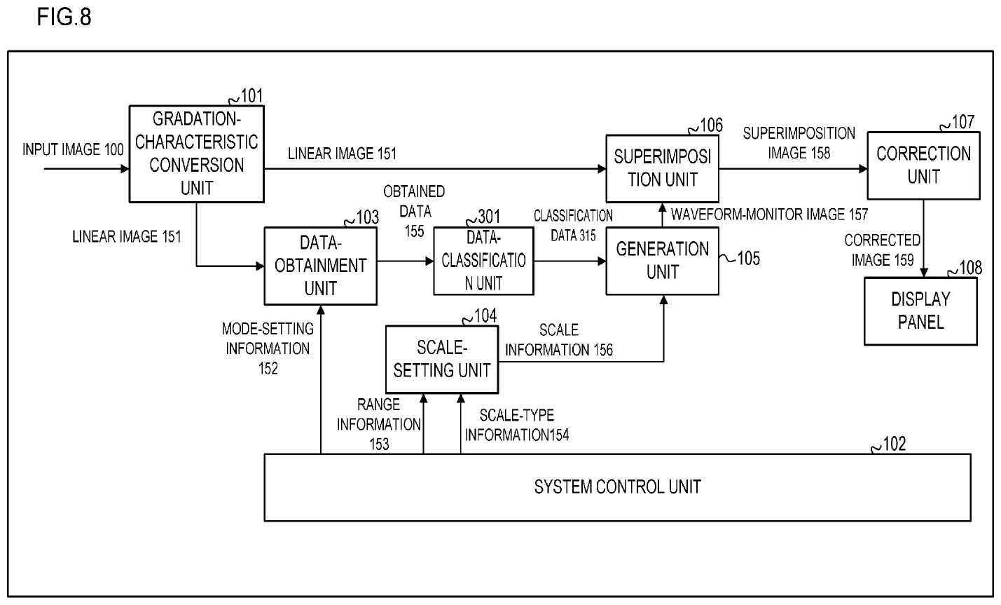

FIG. 8 shows the configuration of the display device of the third embodiment. In addition to the functional units of the first embodiment, the display device of the present embodiment includes a data-classification unit 301. Only the differences between the present embodiment and the first embodiment are described below.

The data-classification unit 301 classifies the obtained data 155 into data having a at least predetermined brightness and data having not more than the predetermined brightness. In the present embodiment, the data-classification unit 301 classifies the brightnesses of the pixels along the horizontal line indicated by the mode-setting information 152 into brightness data of at least 1000 cd/m² and brightness data of not more than 1000 cd/m². The data-classification unit 301 outputs the two pieces of classified data to the generation unit 105 as classification data 315.

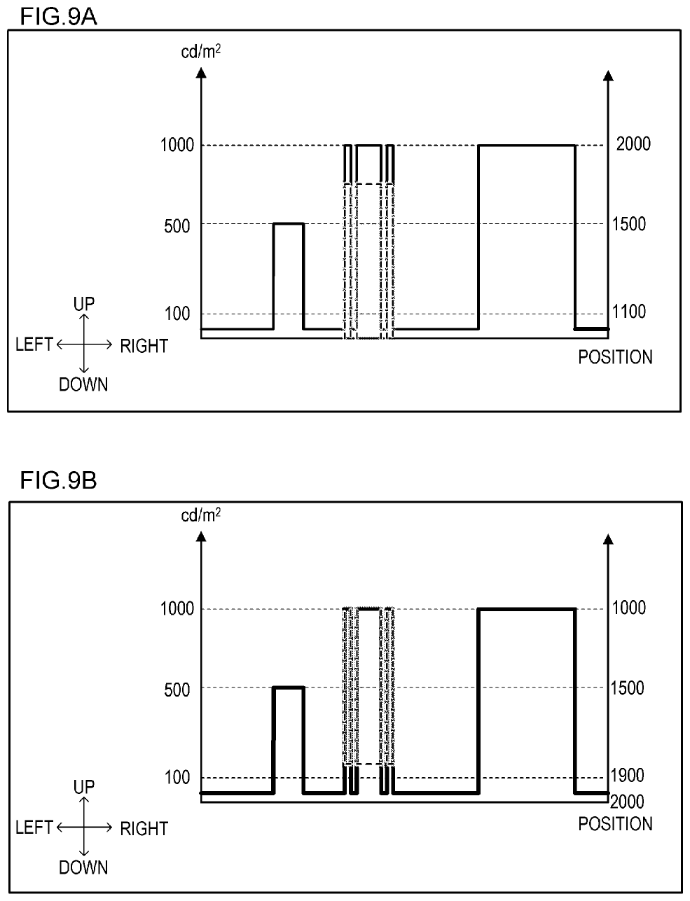

When the range information 153 indicates the narrow range, the scale-setting unit 104 sets a scale of 0 to 1000 cd/m² on the left side and a scale of 1000 to 2000 cd/m² on the right side, as with the scales on the vertical axes of the waveform-monitor image 157 shown in FIG. 9A. When the range information 153 indicates the full range, the scale-setting unit 104 performs the same processes as in the first embodiment. The scale-setting unit 104 sets the scales such that a variation in brightness and a variation in the position on each vertical axis (scale value) have linear characteristics over the entire brightness range. The scale-setting unit 104 performs the other processes in the same manner as the first embodiment.

Based on the classification data 315, the generation unit 105 generates a waveform-monitor image 157 that displays two brightness ranges superimposed as shown in FIG. 9A. FIG. 9A shows a waveform-monitor image 157 to be superimposed onto the image shown in FIG. 4A The waveform-monitor image 157 shown in FIG. 9A has a scale of 0 to 1000 cd/m² displayed on the left side and a scale of 1000 to 2000 cd/m² displayed on the right side as scales on the vertical axes.

The waveform-monitor image 157 of the present embodiment indicates brightnesses of 0 to 1000 cd/m² by a solid line, and brightnesses of 1000 to 2000 cd/m² by a broken line. These two lines are superimposed on each other. The present embodiment displays the two lines (brightnesses in different ranges) in different display appearances by using a solid line and a broken line, but the two lines may be displayed in different display appearances by using different colors.

In the present embodiment, the display width (range width, size) for a range of at least a predetermined brightness is the same as the display width for a range of not more than the predetermined brightness. This improves the legibility of the waveform-monitor image 157.

Further, as shown in FIG. 9B, the waveform-monitor image 157 may display a scale of 0 to 1000 cd/m² on the left side and a scale of 1000 to 2000 cd/m² on the right side as vertical axis scales, and the right scale may have 2000 on the lower side and 1000 on the upper side. In this case, with the broken line indicating the range of 1000 to 2000 cd/m, a lower brightness is plotted at a higher position. This increases the continuity at 1000 cd/m² (predetermined brightness) in the waveform-monitor image 157, thereby improving the legibility of the waveform-monitor image 157.

### Fourth Embodiment

A display device of a fourth embodiment sets a scale of a waveform-monitor image based on the information input by a user.

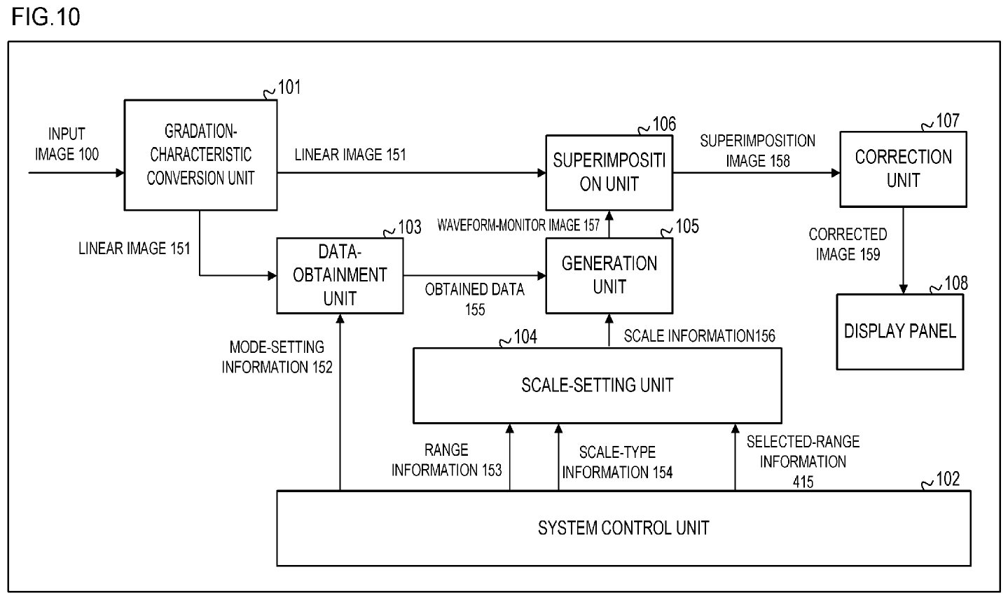

FIG. 10 shows the configuration of the display device of the fourth embodiment. In the same manner as the first embodiment, the display device of the present embodiment includes a gradation-characteristic conversion unit 101, a system control unit 102, a data-obtainment unit 103, a scale-setting unit 104, a generation unit 105, a superimposition unit 106, a correction unit 107, and a display panel 108. Only the differences between the present embodiment and the first embodiment are described below.

The system control unit 102 outputs selected-range information 415 indicating a range of a scale of the waveform-monitor image 157. The selected-range information 415 is input by a user.

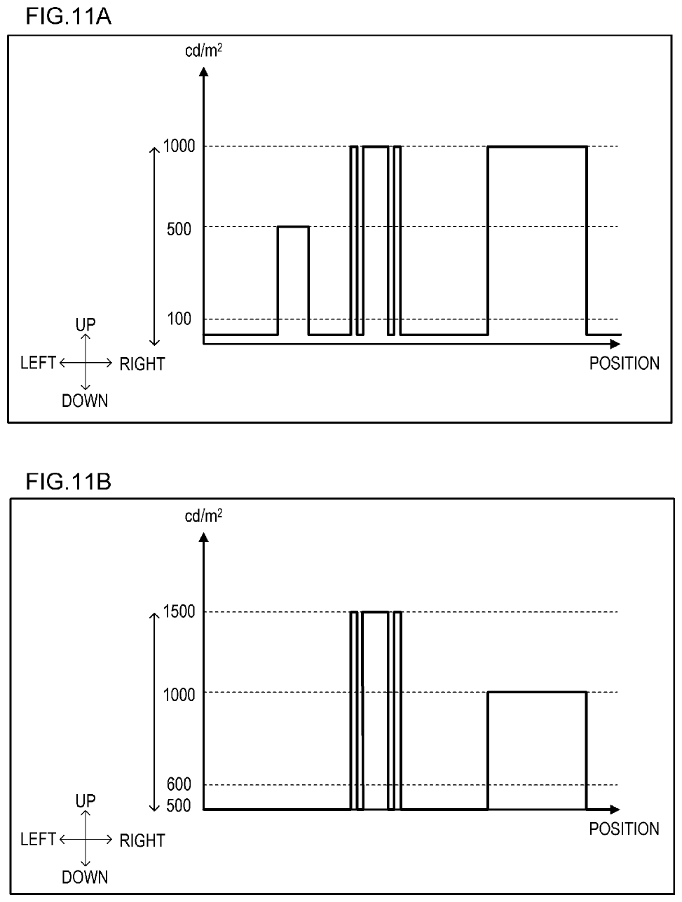

The scale-setting unit 104 sets a scale of the waveform-monitor image 157 based on the selected-range information 415 instead of the range information 153. That is, the scale-setting unit 104 may set a scale on the left side of the waveform-monitor image 157 as shown in FIGS. 11A and 11B.

For example, when the selected-range information 415 indicates 0 to 1000 cd/m², the scale-setting unit 104 sets a scale with the maximum value of 1000 cd/m² and the minimum value of 0 cd/m² as shown in FIG. 11A. When the selected-range information 415 indicates 500 to 1500 cd/m², the scale-setting unit 104 sets a scale with the maximum value of 1500 cd/m² and the minimum value of 500 cd/m² as shown in FIG. 11B.

This allows the user to check the desired brightness range in detail, improving the legibility of the waveform-monitor image 157.

The display devices of the first to fourth embodiments improve the legibility for checking the brightnesses in the input image 100 by suitably displaying a waveform-monitor image 157. The display of the waveform-monitor image 157 of the first to fourth embodiments may be changeable. For example, when a user inputs selected-range information 415, the scale-setting unit 104 may set (reset) the scale according to the selected-range information 415 as described in the fourth embodiment. In absence of selected-range information 415 input by a user, the scale-setting unit 104 sets the scale based on the range information 153 as described in the first embodiment. Further, the display device may include a changing unit (not shown), which changes the display among the waveform-monitor images 157 of the first to fourth embodiments according to an instruction from a user to the changing unit.

Further, the display width setting methods or other aspects in the first to fourth embodiments may be combined with one another. For example, the display width for 1000 to 2000 cd/m² and the display width for 0 to 1000 cd/m² in the waveform-monitor image 157 may be set based on the size of the waveform-monitor image 157, the range of corresponding HLG data values, and the brightnesses of the pixels in the input image 100.

The waveform-monitor image 157 described above indicates the brightnesses (brightness data) in the input image 100. However, a waveform-monitor image may be used that indicates the brightnesses (display brightness) in a display image (image based on the input image 100) displayed on the display panel 108. Such a configuration allows the user to easily recognize the brightnesses in the image that is actually displayed.

In the examples described above, each embodiment displays (generates) a waveform-monitor image that indicates the relationship between brightness and position. However, the embodiments are also applicable to any graph images that have a scale for brightness on an axis of the graph (such as a histogram image). The use of an embodiment increases the display size for a brightness range that corresponds to many data values, thereby improving the legibility of the graph.

The present invention improves the legibility of a graph indicating brightnesses in an image.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-003704, filed on Jan. 14, 2020, which is hereby incorporated by reference herein in its entirety.

What is claimed is:

1. An information-processing apparatus comprising at least one memory and at least one processor which function as:
an obtainment unit configured to obtain an input image; and
a generation unit configured to generate a graph image indicating brightnesses in the input image, the graph image having at least an axis representing brightness, wherein
the generation unit, in a case of generating the graph image indicating a brightness range including a first range and a second range, with the first range being a brightness range of not more than a predetermined brightness, and with the second range being a brightness range of at least the predetermined brightness and having a brightness span of at least a brightness span of the first range, generates the graph image such that a size of the second range is smaller than a size of the first range.

2. The information-processing apparatus according to claim 1, wherein the predetermined brightness is 1000 cd/m².

3. The information-processing apparatus according to claim 1, wherein the at least one memory and the at least one processor further function as a setting unit configured to set the brightness range indicated by the graph image.

4. The information-processing apparatus according to claim 3, wherein the setting unit, in a case where information indicating a range including a brightness higher than the predetermined brightness is obtained, sets the brightness range indicated by the graph image such that the brightness range includes the first range and second range.

5. The information-processing apparatus according to claim 3, wherein the setting unit, in a case where the generation unit generates the graph image indicating the brightness range including the first range and second range, further sets the size of the first range and the size of the second range in the graph image.

6. The information-processing apparatus according to claim 5, wherein the setting unit sets the size of the first range and the size of the second range in the graph image based on an extent of a range of data values in the input image that correspond to the first range and an extent of a range of data values in the input image that correspond to the second range.

7. The information-processing apparatus according to claim 6, wherein the setting unit sets the size of the first range and the size of the second range such that a ratio between the extent of the range of the data values in the input image that correspond to the first range and the extent of the range of the data values in the input image that correspond to the second range is equal to a ratio between the size of the first range and the size of the second range in the graph image.

8. The information-processing apparatus according to claim 5, wherein the setting unit, in a case where, among pixels in the input image, a number of pixels that have a brightness higher than the predetermined brightness exceeds a predetermined number, sets the size of the second range larger in the graph image than in a case where the number of the pixels that have a brightness higher than the predetermined brightness is less than the predetermined number.

9. The information-processing apparatus according to claim 5, wherein, the setting image, in a case where a size of the graph image is larger than a predetermined size, sets the size of the second range relative to the size of the first range larger in the graph image than in a case where the size of the graph image is smaller than the predetermined size.

10. The information-processing apparatus according to claim 3, wherein the setting unit, in a case where a user inputs a brightness range, resets to the input brightness range the brightness range indicated by the graph image.

11. The information-processing apparatus according to claim 1, wherein a size of the graph image is changeable by user input.

12. The information-processing apparatus according to claim 1, wherein
in the first range, a variation in brightness is proportional to a variation in a position indicating the brightness, and
in the second range, a variation in brightness is not proportional to a variation in a position indicating the brightness.

13. The information-processing apparatus according to claim 1, wherein the graph image is a waveform-monitor image indicating a relationship between brightnesses and positions in the input image.

14. A display device comprising:
the information-processing apparatus according to claim 1; and
a display that displays an image in which the graph image is superimposed on an image that is based on the input image.

15. An information-processing apparatus comprising at least one memory and at least one processor which function as:
an obtainment unit configured to obtain an input image; and
a generation unit configured to generate a graph image indicating brightnesses in the input image, the graph image having at least an axis representing brightness, wherein
the generation unit, in a case of generating the graph image indicating a brightness range including a first range and a second range, with the first range being a brightness range less than a predetermined brightness, and with the second range being a brightness range greater the predetermined brightness, generates the graph image such that the first range and the second range are superimposed on each other.

16. The information-processing apparatus according to claim 15, wherein in the graph image, a size of the first range is equal to a size of the second range.

17. The information-processing apparatus according to claim 15, wherein in the graph image, a brightness in the first range and a brightness in the second range are indicated in display appearances different from each other.

18. An information-processing method comprising:
an obtainment step of obtaining an input image; and
a generation step of generating a graph image indicating brightnesses in the input image, the graph image having at least an axis representing brightness, wherein
the generation step, in a case of generating the graph image indicating a brightness range including a first range and a second range, with the first range being a brightness range of not more than a predetermined brightness, and with the second range being a brightness range of at least the predetermined brightness and having a brightness span of at least a brightness span of the first range, includes generating the graph image such that a size of the second range is smaller than a size of the first range.

19. An information-processing method comprising:
an obtainment step of obtaining an input image; and
a generation step of generating a graph image indicating brightnesses in the input image, the graph image having at least an axis representing brightness, wherein
the generation step, in a case of generating the graph image indicating a brightness range including a first range and a second range, with the first range being a brightness range less than a predetermined brightness, with the second range being a brightness range greater than the predetermined brightness, includes generating the graph image such that the first range and the second range are superimposed on each other.

20. A computer-readable non-transitory storage medium storing a program for causing a computer to function as each unit of the information-processing apparatus according to claim 1.
